(19) United States
(12) Patent Application Publication
(10) Pub. No.: US 2019/0031104 A1
(43) Pub. Date: Jan. 31, 2019

(54) ELECTRIC CIRCUIT FOR ELECTRONIC MIRROR

(71) Applicant: Panasonic Intellectual Property Management Co., Ltd., Osaka (JP)

(72) Inventors: YASUTAKA MATSUMOTO, Tokyo (JP); AKIRA YOSHIDA, Kanagawa (JP)

(21) Appl. No.: 15/758,742

(22) PCT Filed: Feb. 2, 2017
(86) PCT No.: PCT/JP2017/003772

§ 371 Date: Mar. 9, 2018

(30) Foreign Application Priority Data
Mar. 29, 2016 (JP) 2016-065409

(51) Int. Cl. B60R 1/12; H04N 7/18

(52) U.S. Cl. CPC B60R 1/12; H04N 7/181; H04N 5/2252; B60R 2300/00; B60R 2001/1253

(57) ABSTRACT

An electric circuit for an electronic mirror includes first and second image sensors, an image processing unit, a serializer unit, and a power supply unit. The image processing unit processes image signals received from the first and second image sensors, and outputs processed image signals corresponding to these image signals. The serializer unit converts the processed image signals into serial signals, respectively. The power supply unit supplies operating power to the first and second image sensors, the image processing unit, and the serializer unit. In the electric circuit, at least either of the following processes is performed: (1) The image processing unit alternately processes the two kinds of image signals; and (2) The serializer unit alternately processes the two kinds of processed image signals.

### TECHNICAL FIELD

The present disclosure relates to an electric circuit for an electronic mirror.

### BACKGROUND ART

In recent vehicles, the rearview or sideview mirror has been replaced by an electronic mirror, which displays images of the outside of these vehicles captured by cameras mounted to the vehicles. Such an electronic mirror advantageously helps the driver to see the region that the driver cannot see through the rearview or sideview mirror.

The cameras for the electronic mirror with such functions are intended to allow the driver to see a region larger than the region visible through the existing sideview mirror. To achieve this objective, electronic mirrors of this type are typically placed in a position formerly occupied by the existing sideview mirror. A camera with a small field of view has many blind spots, whereas a camera with a large field of view cannot capture distant images. To complement each other, two or more cameras with different fields of view are used to extend the region visible by the driver.

However, if a storage case containing two or more cameras is placed in the position formerly occupied by the sideview mirror, the shape of the sideview mirror does not allow leaving much space in the storage case.

To solve this problem, Patent Literature 1 discloses a structure in which a single image sensor unit is stored in the storage case and mechanically moving this unit between two lenses so as to make the unit receive light from both lenses.

### CITATION LIST

### Patent Literature

PTL 1: U.S. Patent Publication No. 2014/0168438

### SUMMARY OF THE INVENTION

The present disclosure provides an electric circuit suitable for an electronic mirror including two or more lenses.

The electric circuit according to the present disclosure is used for an electronic mirror which is housed in a case and includes first and second lenses. The electric circuit includes first and second image sensors, an image processing unit, a serializer unit, and a power supply unit. The first image sensor is disposed on the first lens, and the second image sensor is disposed on the second lens. The image processing unit processes a first image signal received from the first image sensor and outputs a first processed image signal, and also processes a second image signal received from the second image sensor and outputs a second processed image signal. The serializer unit converts the first processed image signal and the second processed image signal into a first serial signal and a second serial signal, respectively, and sends them to an external device outside the case. The power supply unit supplies operating power to the first and second image sensors, the image processing unit, and the serializer unit. In the electric circuit, at least either of the following processes is performed: (1) The image processing unit alternately processes the first image signal and the second image signal; and (2) The serializer unit alternately processes the first processed image signal and the second processed image signal.

The electric circuit according to the present disclosure, which is used for an electronic mirror, is compact and contributes to reduce the product cost.

### BRIEF DESCRIPTION OF DRAWINGS

FIG. 1 shows an example of the electric circuit according to a first exemplary embodiment, which is used for an electronic mirror.

FIG. 2 shows another example of the electric circuit according to the first exemplary embodiment, which is used for an electronic mirror.

FIG. 3 shows still another example of the electric circuit according to the first exemplary embodiment, which is used for an electronic mirror.

FIG. 4 shows still another example of the electric circuit according to the first exemplary embodiment, which is used for an electronic mirror.

FIG. 5 is an external view of a sideview mirror equipped with an electronic mirror including the electric circuit according to the first exemplary embodiment.

FIG. 6 is an external view of the sideview mirror shown in FIG. 5 when seen from behind the vehicle body.

FIG. 7 is an external view of a sideview mirror equipped with an electronic mirror including an electric circuit according to a second exemplary embodiment.

FIG. 8 is an external view of the sideview mirror shown in FIG. 7 when seen from behind the vehicle body.

### DESCRIPTION OF EMBODIMENTS

Prior to describing exemplary embodiments of the present disclosure, problems in the known art will now be briefly described. According to Patent Literature 1, the image sensor is mechanically moved to capture images with different fields of view, and this raises various problems. For example, the image sensor and lenses tend to collect dust. Furthermore, the image sensor cannot be focused to the size of several microns by simply being moved mechanically.

In particular, attempts have been made to further extend the region visible by the driver by providing the sideview mirror with a fish-eye lens (with a 180-degree field of view) in addition to a typical convex lens. However, these lenses with different fields of view have different back focal lengths. This makes it further difficult to adjust the focuses of the lenses by mechanically moving the image sensor in the manner shown in Patent Literature 1.

Hereinafter, exemplary embodiments of the present disclosure will be described with reference to drawings.

### First Exemplary Embodiment

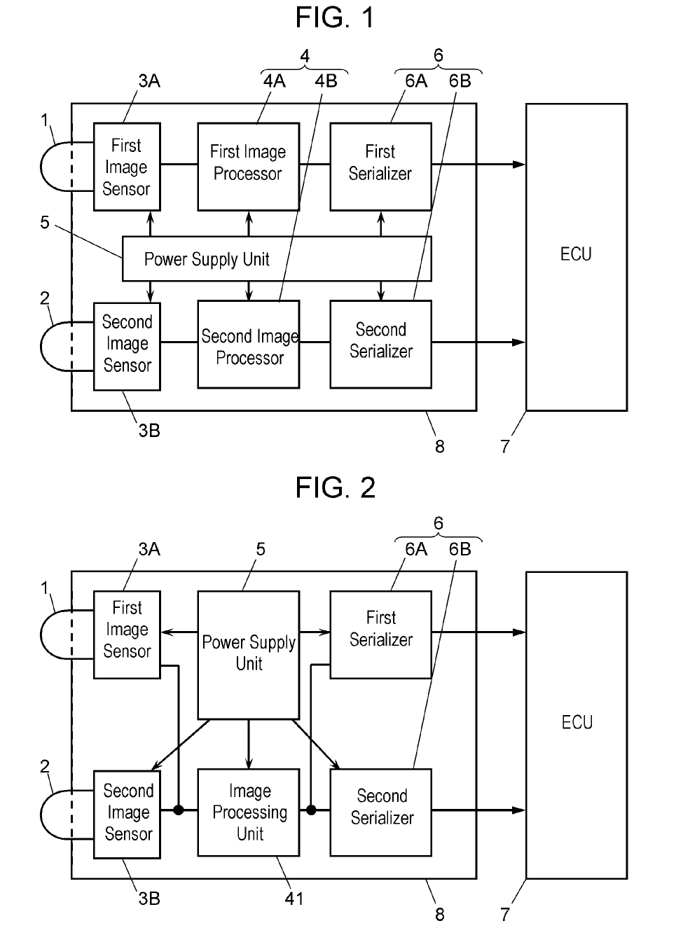

FIGS. 1 to 4 show different examples of the electric circuit according to a first exemplary embodiment of the present disclosure, which is used for an electronic mirror.

The electric circuit shown in each of FIGS. 1 to 4 is connected to first lens 1 (hereinafter, lens 1) and second lens 2 (hereinafter, lens 2), which have different fields of view from each other. In each electric circuit, any of circuit components composing the electronic mirror is shared between lenses 1 and 2.

Lens 1 can be a 104-degree lens, and lens 2 can be a 180-degree fish-eye lens, for example. Each electric circuit includes first image sensor 3A (hereinafter, sensor 3A), second image sensor 3B (hereinafter, sensor 3B), image processing unit 4 or 41, serializer unit 6 or 61, and power supply unit 5. Sensor 3A is disposed on lens 1, and sensor 3B is disposed on lens 2. Image processing unit 4 or 41 receives a first image signal from sensor 3A, and processes the first image signal to be output as a first processed image signal. Image processing unit 4 or 41 also receives a second image signal from sensor 3B, and processes the second image signal to be output as a second processed image signal. Serializer unit 6 or 61 converts the first processed image signal and the second processed image signal into a first serial signal and a second serial signal, respectively, and outputs them to an external device, which is in the outside of case 8. As an example of the external device, each of FIGS. 1 to 4 shows electronic control unit (ECU) 7.

In the electronic mirror according to the present exemplary embodiment, sensors 3A and 3B are respectively (separately) provided for lenses 1 and 2 with different fields of view from each other.

Each of sensors 3A and 3B includes, for example, a CMOS or CCD sensor having photodiodes arranged in a matrix. Such a sensor generates an image signal. Such an image signal contains RGB luminance information for each pixel (e.g., luminance values in 256 gradations of each of RGB). Each of sensors 3A and 3B further includes an analog-digital conversion circuit. This circuit converts the image signal generated by the CMOS or CCD sensor into a digital signal, and sends the digital signal to image processing unit 4 or 41. Thus, sensors 3A and 3B send image signals frame by frame to image processing unit 4 or 41.

Image processing unit 4 or 41 applies processes such as data interpolation, and color or luminance correction to the image signals received frame by frame from sensors 3A and 3B.

Power supply unit 5 includes a power source such as lithium ion batteries, and supplies operating power to sensors 3A and 3B, image processing unit 4 or 41, and serializer unit 6 or 61.

Serializer unit 6 or 61 converts the image signals, which are parallel signals received from image processing units 4 and 41, into serial signals. Serializer unit 6 or 61 then sends the serial signals converted from the image signals to ECU 7 placed outside a case for the sideview mirror.

ECU 7 displays captured images on a display device (not shown) based on the image signals received from serializer unit 6 or 61.

The following describes how the electric circuit according to the present exemplary embodiment has been reduced in size.

The case for the sideview mirror is too small to store two cameras whose lenses have different fields of view to cover side-front and side-rear views. These problems can be solved by sharing as many circuit components as possible between the two cameras. As a result, the electric circuit has been reduced in size and cost. The term “the field of view of a lens” indicates the angle at which the region is captured by a camera with the lens, or in other words, indicates a degree of the distortion of the lens.

A first approach to achieving commonality of circuit components is to share power supply unit 5 as shown in FIG. 1. In this approach, images are sent from sensors 3A and 3B by means of two systems to ECU 7. Thus, image processing unit 4 includes first image processor 4A (hereinafter, processor 4A) and second image processor 4B (hereinafter, processor 4B). Processor 4A processes the first image signal received from sensor 3A, and processor 4B processes the second image signal received from sensor 3B. As a result, processor 4A outputs the first processed image signal, and processor 4B outputs the second processed image signal. Serializer unit 6 includes first serializer 6A (hereinafter, serializer 6A) and second serializer 6B (hereinafter, serializer 6B). Serializer 6A converts the first processed image signal into the first serial signal, and serializer 6B converts the second processed image signal into the second serial signal.

Power supply unit 5 supplies the operating power to sensors 3A and 3B, processors 4A and 4B, and serializers 6A and 6B in parallel. This allows maintaining a desired operating voltage.

A second approach is to share power supply unit 5 and to use image processing unit 41, which is a shared component, as shown in FIG. 2.

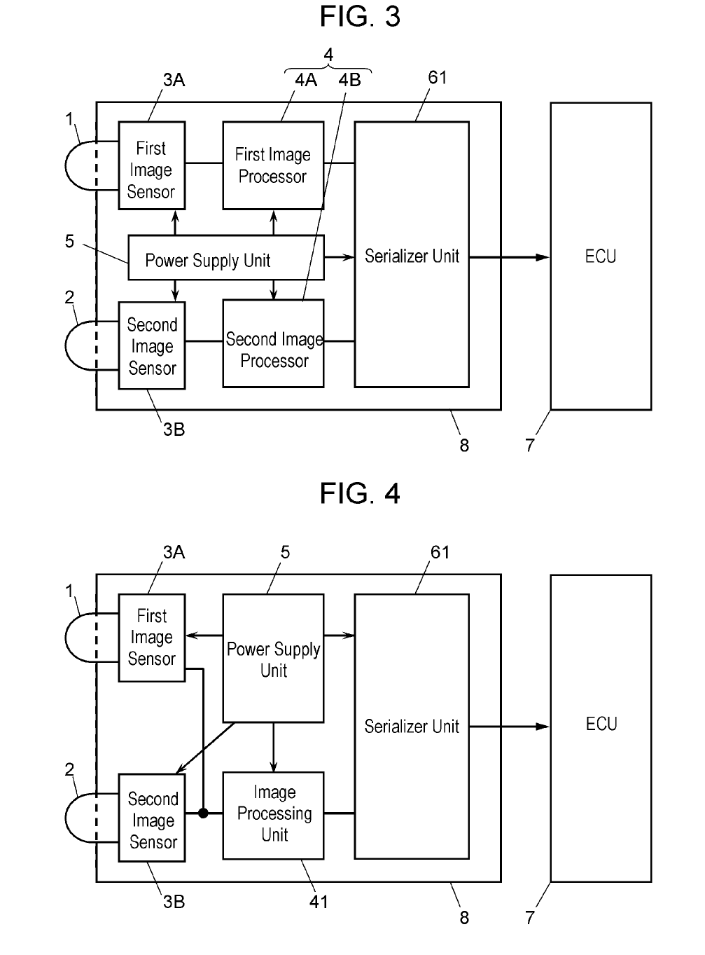

A third approach is to share power supply unit 5 and to use serializer unit 61, which is a shared component, as shown in FIG. 3.

A fourth approach is to share power supply unit 5, and image processing unit 41 and serializer unit 61, each of which is a shared component, thereby sending images by means of a single system to ECU 7 as shown in FIG. 4.

Each of image processing unit 41 and serializer unit 61 processes the image signals received from sensor 3A and from sensor 3B alternately, for example, frame by frame. To be more specific, image processing unit 41 alternately processes the first image signal and the second image signal. Similarly, serializer unit 61 alternately processes the first processed image signal and the second processed image signal. In other words, image processing unit 41 and serializer unit 61 have the same basic functions as processor 4A or 4B, and serializer 6A or 6B, respectively.

The electric circuit can be downsized according to one of the above-described three approaches by considering disadvantages of using at least one of image processing unit 41 and serializer unit 61, each of which is a shared component, and also considering convenience and other advantages of using image processors 4A and 4B, or serializers 6A and 6B, in addition to sharing power supply unit 5.

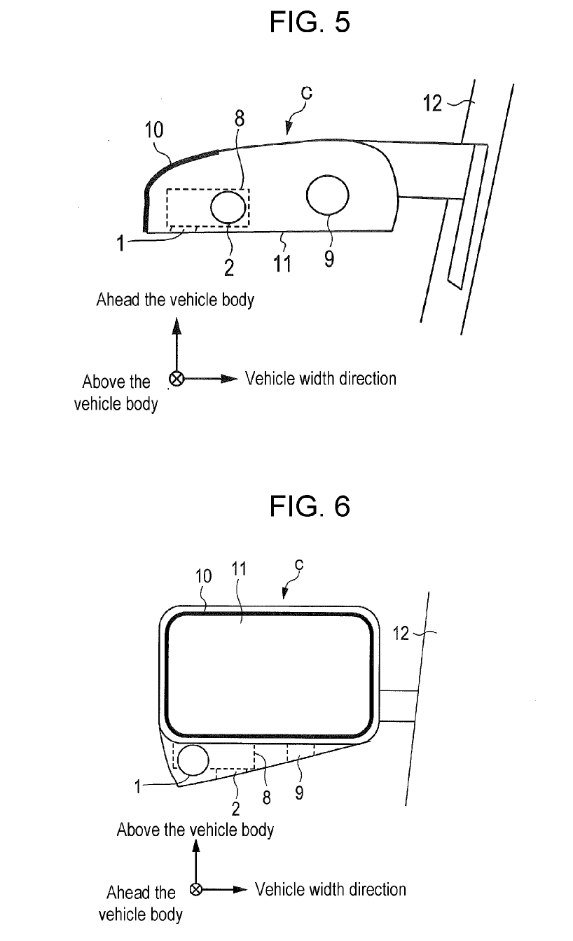

FIGS. 5 and 6 are external views of the sideview mirror equipped with the electronic mirror including the electric circuit according to the present exemplary embodiment, showing examples of the position where lenses 1, 2 and other components are placed. The sideview mirror appears as shown in FIG. 5 when seen from underneath of the vehicle body and as shown in FIG. 6 when seen from behind the vehicle body. Lens 1 is a 104-degree lens, whereas lens 2 is a 180-degree fish-eye lens, both of which are partially stored in case 8. Alternatively, these lenses may entirely be exposed from case 8. Case 8 is stored together with illuminating device 9 in case C for the sideview mirror. Indicator 10 and mirror unit 11 are disposed outside case C, which is attached to vehicle body 12.

Lens 1 is used, for example, for a camera to cover a sire-rear view. Lens 1 is retracted in case C from mirror unit 11 by 3 to 5 mm so as to be protected from being bumped or collecting dust. Mirror unit 11 helps the driver to see vehicles (cars and motorcycles) approaching the own vehicle from behind.

The camera with a 104-degree field of view and equipped with lens 1 can play a role as a sensing camera to perform detection inside it. For example, the first image signal output from lens 1 is recognized as an image by image processing unit 4 or 41 and is used to detect vehicles approaching the own vehicle from behind. If any vehicle is detected approaching the own vehicle from behind, image processing unit 4 or 41 sends a detection signal to ECU 7, which can sound an alarm for safety.

When the camera has such a safety function, image processing unit 4 is more preferable than image processing unit 41 in terms of processing load. In other words, it is preferable to provide, as separate circuit components, processor 4A for processing the first image signal generated by sensor 3A through lens 1, and processor 4B for processing the second image signal generated by sensor 3B through lens 2.

The camera with a 180-degree field of view and equipped with lens 2 can be used as a camera to cover a side-front view. Lens 2 is placed to a downward direction so as to capture the region below the sideview mirror.

When the cameras with 180- and 104-degree fields of view are used, the electric circuit is stored in case C for the sideview mirror, where power supply unit 5 alone is shared as shown in FIG. 1. The camera with a 104-degree field of view, which is intended to cover a region of 104 degrees or more, may be replaced by three cameras with fields of view of 25, 52, and 58 degrees.

In cases where the above-mentioned safety function is not required, not only the camera with the field of view of 104 degrees, but the combination of the cameras with the fields of view of 25, 52, and 58 degrees do not have the problem of processing load. Consequently, image processing unit 41, which is a shared component between the camera with a 180-degree field of view and the camera with the field of view of 104 degrees or the combination of cameras, can perform necessary operations. Thus, the electric circuit can include power supply unit 5 and image processing unit 41, which are shared components (FIG. 2). This structure is more compact than the structure shown in FIG. 1. Furthermore, also using serializer unit 61, which is a shared component, can make the electric circuit even more compact (FIG. 4).

The camera with a 180-degree field of view corresponds to cameras to cover side-front and side-rear views, and is mainly used while the vehicle is parking, stopping, running, or starting up. The cameras with 104-, 25-, 52-, and 58-degree fields of view are used to cover a side-rear view. Lenses with smaller fields of view provide clear images even at a large distance. These lenses with different fields of view can be properly selected according to the applications of the electronic mirror.

As described, the electric circuit according to the present exemplary embodiment, which is used for an electronic mirror, includes separate sensors 3A and 3B for different lenses, allowing for a combination of different lenses with different fields of view. Furthermore, at least one of image processing unit 41 and serializer unit 61 alternately processes image signals of two systems, which are received from sensor 3A and from sensor 3B. With this configuration, it is possible to process image signals of two systems, and also to use image processing unit 41 or serializer unit 61, each of which is a shared component of the electronic mirror. In the above description, two image sensors are provided and one system alternately processes two series of image signals. Alternatively, three or more image sensors may be provided and one system may alternately process three or more series of image signals.

In the electric circuit according to the present exemplary embodiment, which is used for an electronic mirror, power supply unit 5 supplies the operating power to sensors 3A and 3B, image processing unit 4 or 41, and serializer unit 6 or 61 in parallel. This allows sharing the power source in the electronic mirror, while maintaining a desired operating voltage.

The electric circuit for an electronic mirror is thus small enough to be stored in case C of the sideview mirror.

### Second Exemplary Embodiment

In the first exemplary embodiment, the cameras are stored in case C for the sideview mirror. Meanwhile, in the second exemplary embodiment, neither case C nor mirror unit 11 is used, and the cameras are directly placed in a position formerly occupied by the sideview mirror. This structure reduces the size of the sideview mirror and the installation area. In the following description, the same components as in the first exemplary embodiment are denoted by the same reference numerals, and thus a detailed description thereof may be omitted.

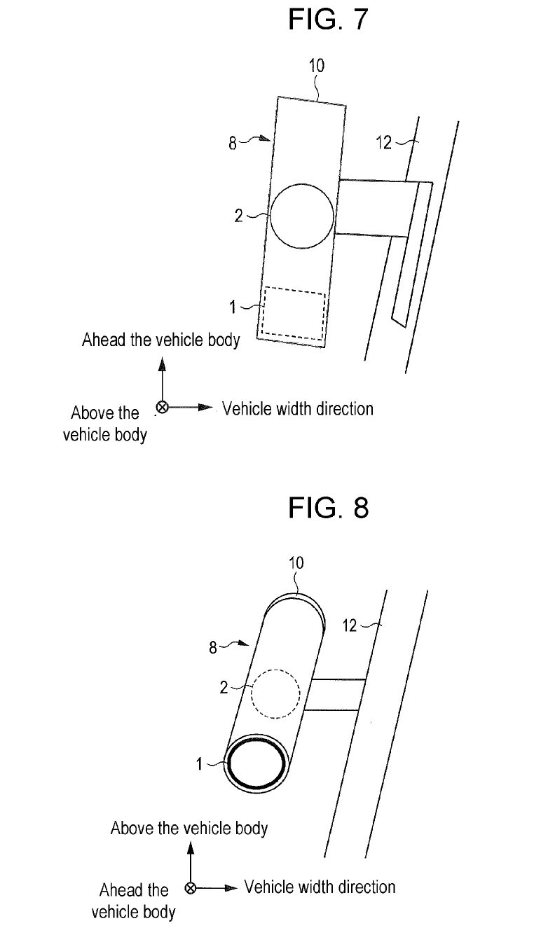

FIGS. 7 and 8 are external views of the sideview mirror equipped with an electronic mirror including the electric circuit according to the present exemplary embodiment, showing examples of the position where lenses 1, 2 and other components are placed. The sideview mirror appears as shown in FIG. 7 when seen from under the vehicle body and as shown in FIG. 8 when seen from behind the vehicle body.

In the present exemplary embodiment, case C for the sideview mirror is eliminated, and case 8 for the cameras is directly placed in the position formerly occupied by the sideview mirror as described above. In short, case 8 also functions as the case for the sideview mirror, which is equipped with the electronic mirror, of the vehicle. In FIGS. 7 and 8, case 8 is shown in an enlarged scale, but is actually the same size as in FIGS. 5 and 6.

In FIGS. 7 and 8, lens 1 with a 104-degree field of view is used for a camera to cover a side-rear view, and lens 2, which is a 180-degree fish-eye lens, is used for a camera to cover a side-front view in the same manner as in FIGS. 5 and 6. In this example, lens 1 is positioned at the rear end of case 8, and lens 2 is positioned at the bottom end of case 8.

In the present exemplary embodiment, similar to the first exemplary embodiment, it is possible to use at least one of image processing unit 41 and serializer unit 61, each of which is a shared component, or to share the power source of power supply unit 5. The electric circuit in the present exemplary embodiment is as compact and low cost as in the first exemplary embodiment. In the present exemplary embodiment, ECU 7 can be provided in vehicle body 12.

The above detailed description is merely exemplary of the present disclosure; the techniques of the present disclosure may be embodied in various forms.

### INDUSTRIAL APPLICABILITY

The electric circuit according to the present disclosure is suitably used in an electronic mirror including two or more lenses.

### REFERENCE MARKS IN THE DRAWINGS

1 first lens (lens)

2 second lens (lens)

3A first image sensor (sensor)

3B second image sensor (sensor)

4, 41 image processing unit

4A first image processor (processor)

4B second image processor (processor)

5 power supply unit

6, 61 serializer unit

6A first serializer (serializer)

6B second serializer (serializer)

7 electronic control unit (ECU)

8 case

9 illuminating device

10 indicator

11 mirror unit

12 vehicle body

C case

1. An electric circuit for an electronic mirror, the electronic mirror being housed in a case and including a first lens and a second lens, the electric circuit comprising:
a first image sensor disposed on the first lens;
a second image sensor disposed on the second lens;
an image processing unit configured
to receive a first image signal from the first image sensor, and process the first image signal to be output as a first processed image signal, and
to receive a second image signal from the second image sensor, and process the second image signal to be output as a second processed image signal;
a serializer unit configured
to convert the first processed image signal and the second processed image signal into a first serial signal and a second serial signal, respectively, and
to send the first serial signal and the second serial signal to an external device outside the case; and
a power supply unit configured to supply operating power to the first image sensor, the second image sensor, the image processing unit, and the serializer unit,
wherein at least either of following processes is performed:
the image processing unit alternately processes the first image signal and the second image signal, and
the serializer unit alternately processes the first processed image signal and the second processed image signal.

2. The electric circuit for the electronic mirror according to claim 1,
wherein the image processing unit includes:
a first image processor configured to process the first image signal; and
a second image processor configured to process the second image signal.

3. The electric circuit for the electronic mirror according to claim 1,
wherein the serializer unit includes:
a first serializer configured to convert the first processed image signal into the first serial signal; and
a second serializer configured to convert the second processed image signal into the second serial signal.

4. The electric circuit for the electronic mirror according to claim 1,
wherein the power supply unit is configured to supply the operating power to the first image sensor, the second image sensor, the image processing unit, and the serializer unit in parallel.

5. The electric circuit for the electronic mirror according to claim 1,
wherein the first lens and the second lens have different fields of view from each other.

6. The electric circuit for the electronic mirror according to claim 1,
wherein the case also serves as a case for a sideview mirror of a vehicle, the case being mounted with the electronic mirror.
